(19) United States
(12) Patent Application Publication
(10) Pub. No.: US 2010/0058321 A1
(43) Pub. Date: Mar. 4, 2010

(54) APPROACH FOR DEPLOYING SOFTWARE TO NETWORK DEVICES

(76) Inventors: Greg L. Anderson, Cupertino, CA (US); Arturo Hung Tse, Cupertino, CA (US); Deniel W. Howard, Cupertino, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/204,755

(22) Filed: Sep. 4, 2008

(51) Int. Cl. G06F 9/445

(52) U.S. Cl. 717/173

(57) ABSTRACT

Techniques are provided for deploying software applications and/or software platforms from a client device to one or more network devices. The client device comprises a client update application and an update library of routines. The update application invokes one of the routines of the update library. In response, the update library sends a plurality of instructions, or commands, and a software application and/or software platform to each of the network devices. The instructions, when processed by each of the network devices, cause the updated software to be installed and any reboot operations to be performed.

### FIELD OF THE INVENTION

The present invention relates to deploying software to multiple printing devices in a network.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Developing and deploying application software is usually a long and tedious process. The development process typically consists of multiple phases of writing, modifying, and compiling code, and testing the application software with the intention that the application software will execute properly in most (if not all) situations. Current approaches for deploying (e.g., at a customer location) applications to printing devices, including multi-functional peripherals (MFPs), require significant human effort and time.

One approach for deploying a software application to a printing device is by having a pre-existing Web application execute on the printing device. Thus, a developer would open a Web browser, access the Web application with the browser, submit authentication information via the browser, and then upload the application by selecting a browse button, selecting the files of the software application that are stored on the developer's computer, and instructing the printing device (via the Web browser) to upload to the selected files. Some software applications require the printing device to perform a reboot operation whereas other software applications do not. Developers may not know when, how often, or even whether the printing device should perform a reboot operation. Unnecessarily performing reboot operations causes “wear and tear” on the printing device and requires a nontrivial amount of time to perform.

One approach for deploying a software platform to a printing device is saving the platform onto a Secure Digital (SD) card, manually inserting the SD card into the printing device, and manually initiating a reboot of the printing device. However, not only do manual steps require significant time for each printing device that is updated, manuals steps are (naturally) prone to human error.

In both approaches, fast deployment becomes unrealistic as the number of printing devices in a network increase. Thus, there is a need to improve the deployment process to decrease the time for development and the probability for error, and to improve the developer's experience.

### SUMMARY

Techniques are provided for remotely deploying software to a printing device. In one embodiment, a client device comprises (1) an update library of routines and (2) a client application that is configured to invoke routines in the update library. In response to the client application invoking a first routine from the update library, the client device is configured to send a plurality of instructions and a different version of the virtual machine over a network to each of the plurality of printing devices. Each of the plurality of printing devices is capable of generating a printed version of an electronic document reflected in electronic print data. Each of the plurality of printing devices, in response to receiving the plurality of instructions and the different version of the virtual machine: (a) uninstalls the current version of the virtual machine; (b) installs the different version of the virtual machine; and (c) performs a reboot operation.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts a structural overview of an update architecture for updating a printing device, according to an embodiment of the invention;

FIG. 2 is a block diagram that depicts a structural overview of an update environment for updating multiple printing devices, according to an embodiment of the invention;

FIG. 3 is a sequence diagram that depicts a process for obtaining device information of a printing device, according to an embodiment of the invention;

FIG. 4 is a sequence diagram that depicts a process for issuing a command to a printing device, according to an embodiment of the invention;

FIG. 5 is a sequence diagram that depicts a process for issuing a command that requires a reboot of a printing device, according to an embodiment of the invention;

FIG. 6 is a sequence diagram that depicts a process for installing a software application that does not require a reboot of a printing device, according to an embodiment of the invention;

FIG. 7 is a sequence diagram that depicts a process for installing a software application that requires a reboot of a printing device, according to an embodiment of the invention;

FIG. 8 is a sequence diagram that depicts a “smart installation” process for installing a software application, according to an embodiment of the invention;

FIG. 9 is a flow diagram that depicts another view of the “smart installation” process, according to an embodiment of the invention;

FIG. 10 is a sequence diagram that depicts a process for uninstalling a software application that does not require a reboot of a printing device, according to an embodiment of the invention;

FIG. 11 is a sequence diagram that depicts a process for uninstalling a software application that requires a reboot of a printing device, according to an embodiment of the invention;

FIG. 12 is a sequence diagram that depicts a process for updating a software platform of a printing device, according to an embodiment of the invention;

FIG. 13 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Remote Executable Operation (RXOP) is an encapsulated library that a software developer integrates into the developer's own product to deploy, over a network, a software application and/or software platform to one or more network devices. RXOP isolates the deployment framework on each network device and allows independent software developers to interact with that deployment framework in a manner that is sustainable, safe, practicable, and supportable.

A software developer uses a client application to develop a new software application and/or software platform upon which one or more applications execute. The new software application and/or software platform may be a newer version of an existing version. Alternatively, the new software application and/or software platform may be for a new class (or family) of devices. The developer causes the client application to invoke a single update routine of RXOP. The developer also indicates one or more printing devices, whose identifies are passed to RXOP. RXOP, in response, sends a plurality of commands, or instructions, to the one or more printing devices along with the developed software application and/or platform. One of the commands or instructions may be to lock the central panel of each printing device before the update command associated with the invoked routine is processed by each printing device. Another command may be to unlock the central panel after the update command is processed. If any reboots are necessary, RXOP generates an appropriate boot script file and causes the one or more printing devices to execute the boot script file.

With RXOP, a software developer is not required to know any software details of the target devices or any of the many complexities of deploying and properly installing software on the target devices.

### Structural Overview

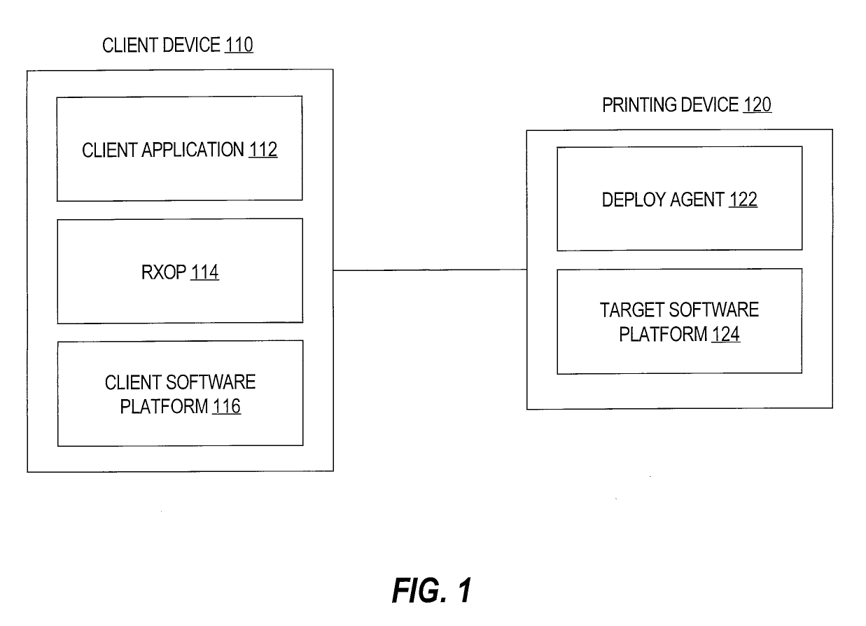

FIG. 1 is a block diagram that depicts a structural overview of an update architecture for deploying software to a printing device, according to an embodiment of the invention. FIG. 1 depicts a client device 110 and a printing device 120. Client device 110 comprises a client application 112, RXOP 114, and a client software platform 116. Printing device 120 comprises a deploy agent 122 and target software platform 124.

In an embodiment, client application 112 is developed by a third party that is different than the party that produced printing device 120. Client application 112, for purposes of brevity, is referred to hereinafter as “client 112.”

As indicated previously, RXOP 114 is an encapsulated library of multiple routines. RXOP 114 supports developers in creating their own deployment applications, such as client 112. “RXOP” is shorthand for “Remote Executable Operation.”

Non-limiting examples of client software platform 116 include the Java Runtime Environment (JRE) and the Microsoft .NET Framework. Similarly, target software platform 124 may be any software platform, such as SDK/J or JDK.

In an embodiment, client device 110 comprises a package of multiple software platforms. This package is used to revert, if necessary, target software platform 124 to a previous version or to a software platform of a different type. For example, if problems arise while target software platform 124 executes a software application, then client 112 may invoke an update platform routine of RXOP 114. RXOP 114, in response, selects the previous version from the package of platforms and creates a boot script file that, when executed by target software platform 124, causes printing device 120 to reboot with the previous version. As another example, target software platform 124 may have been accidentally installed on printing device 120 even though target software platform 124 is not compatible with a class of devices that includes printing device 120. As a result, client 112 invokes an update platform routine of RXOP 114. In response, RXOP 114 selects, from the package of platforms, a different class or type of software platform that corresponds to the class or type of printing device 120. RXOP 114 creates a boot script file which, when executed by target software platform 123, causes printing device 120 to reboot with the different class of software platform.

Client 112 uses RXOP 114 to communicate with deploy agent 122 using, e.g., HTTP connections. Deploy agent 122 is an interface to printing device 120. Deploy agent 122 translates requests (e.g., install, uninstall, reboot), from RXOP 114, into instructions that target software platform 124 can process. As deploy agent 122 accepts requests from RXOP 114, these requests are carried out through target software platform 124 on printing device 120. RXOP 114 is a wrapper to deploy agent 122.

In an embodiment, target software platform 124 comprises two portions: a Java virtual machine portion and a printing device-specific portion. The printing device-specific portion, for example, controls the central panel, allows widgets (or controls) to execute on the central panel, and integrates with different power modes of printing device 120. In an embodiment, the virtual machine portion and the printing device-specific portion are deployed together.

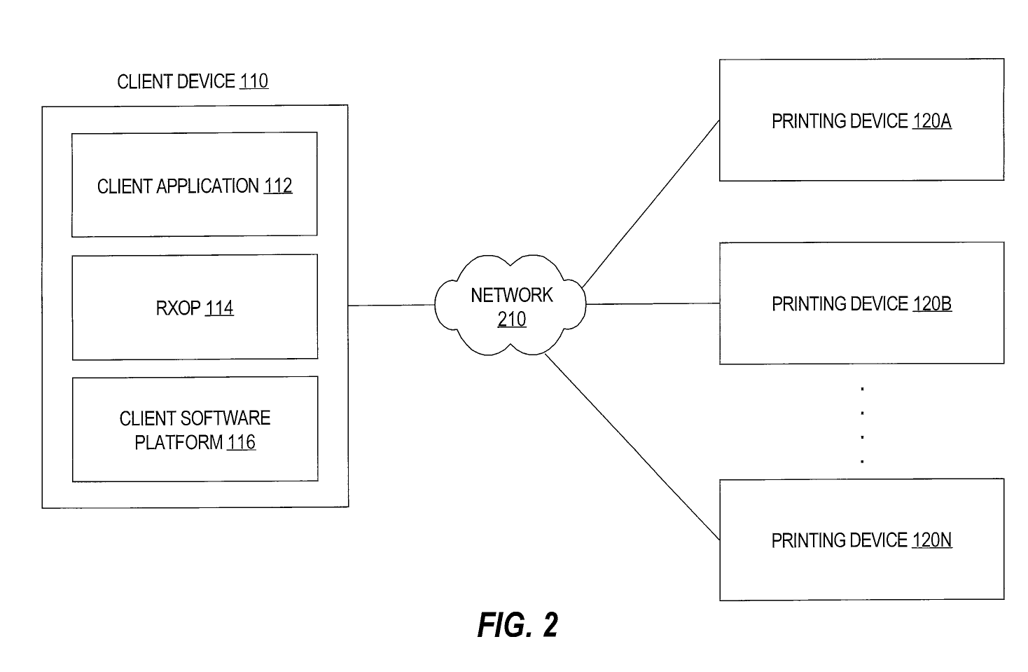

FIG. 2 is a block diagram that depicts a structural overview of an update environment for updating multiple printing devices, according to an embodiment of the invention. As depicted in FIG. 2, RXOP 114 may be used to connect to multiple printing devices 120A-N over network 210 and update printing devices 120A-N in response to client 112 invoking a single update routine of RXOP 114.

### Obtaining Device Information

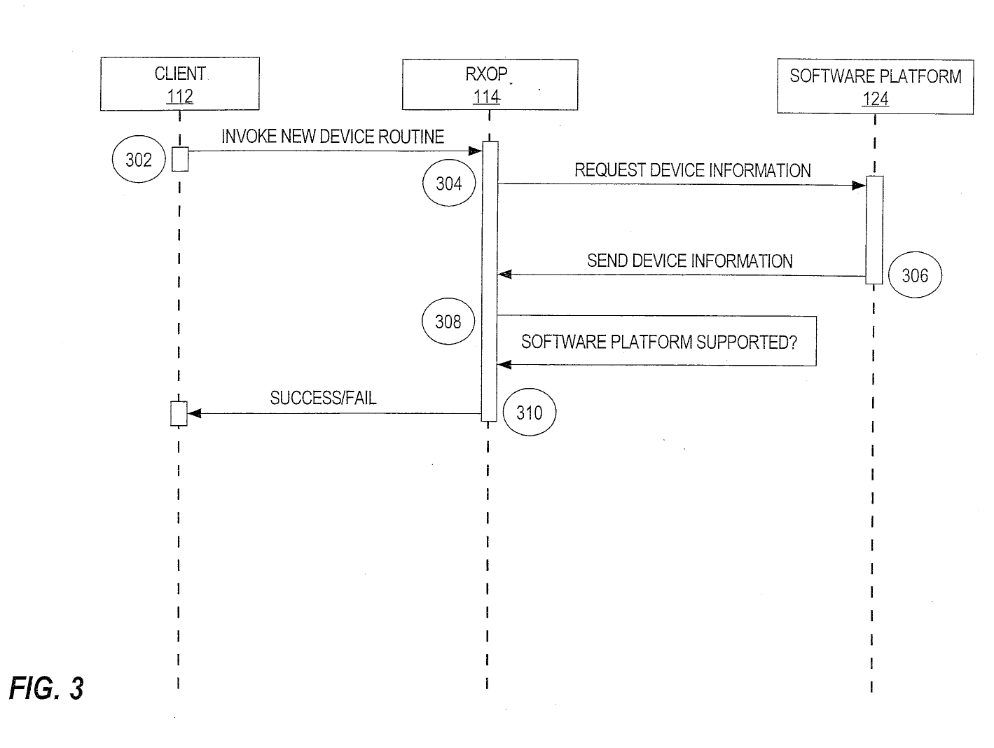

FIG. 3 is a sequence diagram that depicts a process for obtaining device information of a printing device, according to an embodiment of the invention. Client 112 invokes a device initialization routine of RXOP 114 and identifies one or more printing devices (including printing device 120), e.g., by their respective network addresses. In response, at step 304, RXOP 114 requests device information from software platform 124. Non-limiting examples of device information include the device type (e.g., MFP or LP) of printing device 120, the device model of printing device 120, and the version of software platform 124.

At step 306, software platform 124 sends the requested device information to RXOP 114. At step 308, based on this information, RXOP 114 determines whether software platform 124 is a platform that RXOP 114 supports, i.e., that a platform that is known to work on printing device 120. At step 310, RXOP 114 sends a success or fail message to client 112 that indicates whether RXOP 114 supports software platform 124.

### Issuing Commands to One or More Printing Devices

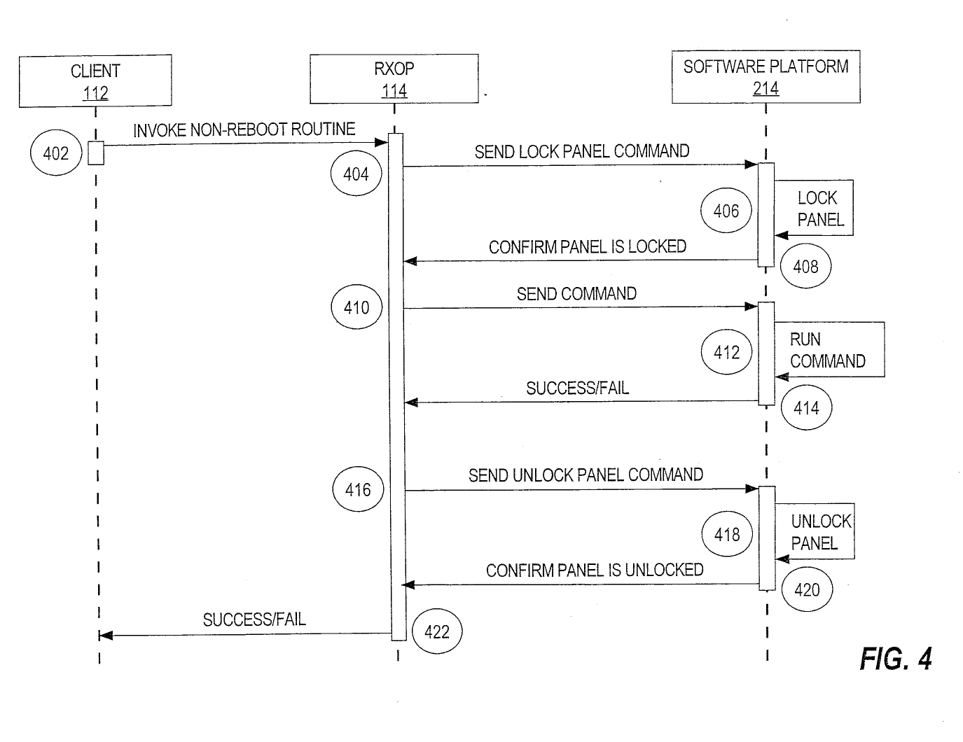

FIG. 4 is a sequence diagram that depicts a process for processing a command, from a client application, that does not require a reboot of a printing device, according to an embodiment of the invention. At step 402, client 112 invokes a routine, of a first type, of RXOP 114 and identifies one or more printing devices (including printing device 120), e.g., by their respective network addresses. In an embodiment, install, uninstall, query device, and query apps are routines of the first type. Such routines are referred to hereinafter as “non-reboot routines.” At step 404, in response to invoking a non-reboot routine, RXOP 114 sends a lock panel command to software platform 124. At step 406, in response to receiving the lock panel command, software platform 124 causes the central panel of printing device 120 to be locked. Printing devices typically have a single central panel, although printing devices may have more than one central panel.

After the lock is confirmed to RXOP 114 (step 408), RXOP 114 sends an update command, that corresponds to the non-reboot routine, to software platform 124 (step 410). At step 412, software platform 124 executes the update command. At step 414, software platform 124 confirms, to RXOP 114, whether the update command completed successfully. At step 416, in response to receiving a notification of a successful completion from printing device 120, RXOP 114 sends an unlock panel command to software platform 124. Accordingly, at step 418, software platform 124 causes the central panel to be unlocked in response to the unlock panel command. At step 420, software platform 124 sends RXOP 114 a notification of whether the unlock panel command completed successfully. At step 422, if the entire process 400 completed successfully, then RXOP 114 sends a successful notification to client 112; otherwise, RXOP 114 sends an unsuccessful notification to client 112. Although this process is depicted in the figures and described herein in the context of locking the central panel, this is not required.

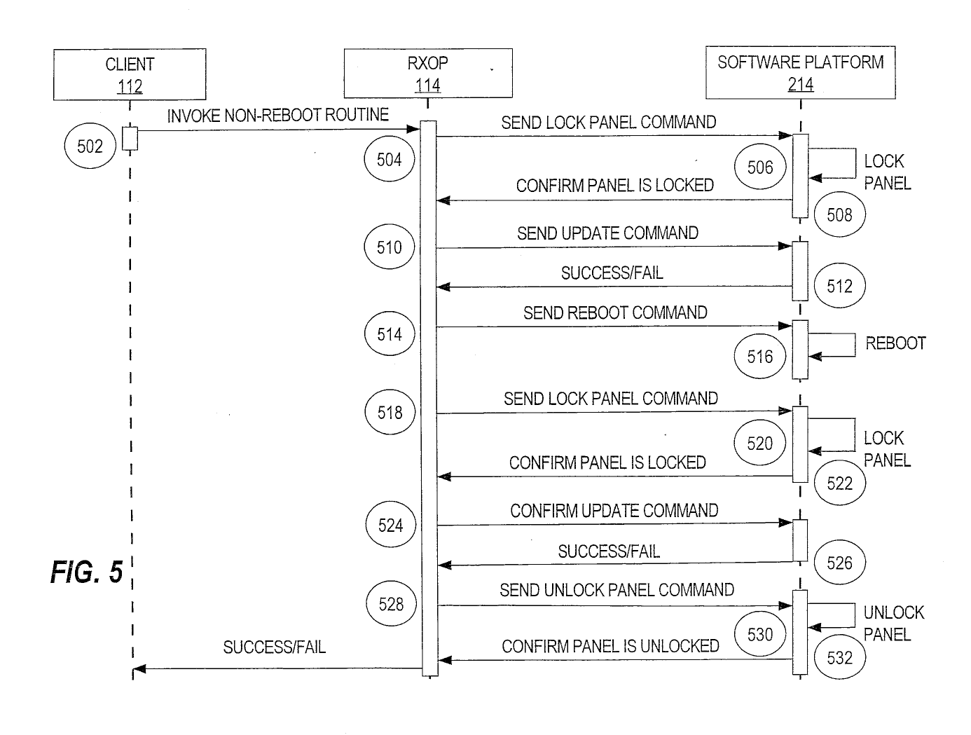

FIG. 5 is a sequence diagram that depicts a process for processing a command, from a client application, that requires a reboot of printing device 120, according to an embodiment of the invention. At step 502, client 112 invokes a routine, of a second type, of RXOP 114. In an embodiment, install, uninstall, software platform update, and reboot are routines of the second type. Such routines that require a reboot are referred to hereinafter as “reboot routines.” At step 504, in response to invoking a reboot routine, RXOP 114 sends a lock panel command to software platform 124. At step 506, in response to receiving the lock panel command, software platform 124 causes the central panel to be locked.

After the lock is confirmed to RXOP 114 (step 508), RXOP 114 sends an update command, that corresponds to the reboot routine, and any necessary software packages to software platform 124 (step 510). At step 512, software platform 124 informs RXOP 114 whether platform 124 received the command and any necessary software packages. At step 514, as part of the update command, RXOP 114 sends a reboot instruction (which may include a boot script file) to software platform 124. At step 516, software platform 124 causes printing device 120 to reboot.

At step 518, after printing device 120 reboots, RXOP 114 sends a lock panel command to software platform 124. At step 520, software platform 124 causes the central panel to be locked. After the lock is confirmed to RXOP 114 (step 522), RXOP 114 confirms (step 524) with software platform 124 whether the update command was performed successfully. For example, if the update command is to update the version of software platform 124, then RXOP 114 requests version information of software platform 124. As another example, if the update command is to install a software application, RXOP 114 confirms with software platform 124 that that software application is installed on printing device 120. Therefore, steps 524-526 may comprise requesting information from software platform 124, or querying software platform 124. If RXOP 114 queries software platform 124, then software platform 124 is configured to send a success or fail message in response to the query.

At step 528, RXOP 114 sends an unlock panel command to software platform 124. At step 530, software platform 124 causes the central panel to unlock and sends (at step 532) a notification to RXOP 114 that the central panel is unlocked. At step 534, if the entire process completed successfully, then RXOP 114 sends a successful notification to client 112; otherwise, RXOP 114 sends an unsuccessful notification to client 112.

### Installing Software Applications

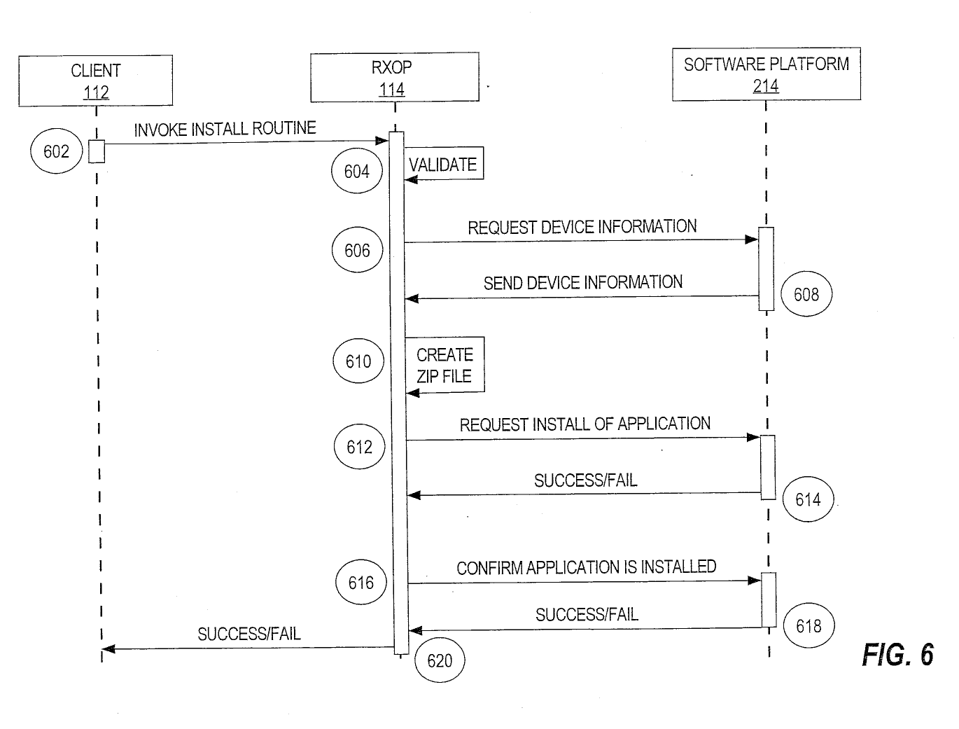

FIG. 6 is a sequence diagram that depicts a process for installing a software application that does not require printing device 120 to perform a reboot operation, according to an embodiment of the invention. At step 602, client 112 invokes a routine to install the software application. At step 604, RXOP 114 validates the software application to determine whether the software application is packaged properly.

In an embodiment, validation comprises determining whether: (1) the software application is packaged in a zip file; (2) the zip file has a flat folder structure; (3) a dalp file is found in the zip file; (4) any jar files are found in the zip file; and (5) the jar file references in the dalp file match the jar files in the zip file. If any of these determinations is negative, then the software application fails the validation test and an appropriate message is sent to client 112.

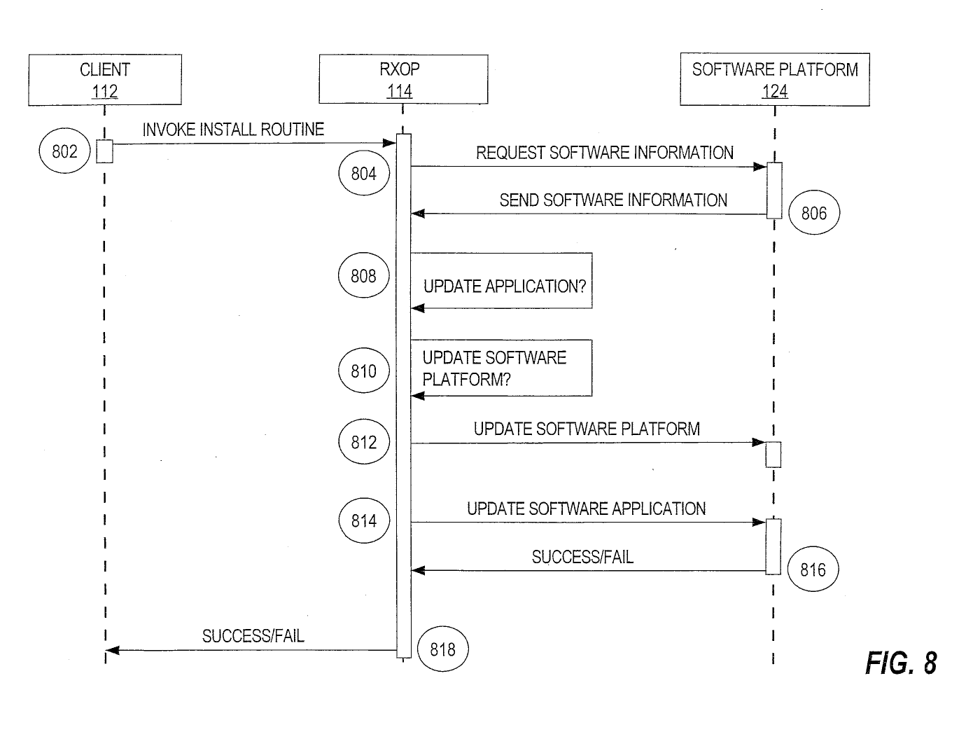

If the software application is packaged properly, then, at step 606, RXOP 114 requests software information from software platform 124 to determine whether this particular software application is supported by printing device 120. Software applications only run on certain versions of a platform, usually to major-version granularity (e.g. any “version 2” platform). However, software applications may be restricted to some minimum minor version number as well (e.g. “4.05 or later”). RXOP 114 checks the versions that the application claims to support against what is installed on printing device 120. This is discussed in more detail below with reference to FIG. 8.

In an embodiment, client 112 sends a software package that includes multiple software applications, multiple software platforms, or a combination of one or more software applications and one or more software platforms. RXOP 114 is responsible for determining which of the packaged software applications and/or software platforms will be deployed to printing device 120. RXOP 114 makes this determination based on the device information retrieved from software platform 124.

At step 608, software platform 124 provides the requested software information to RXOP 114. Once support is confirmed, RXOP 114 creates a zip file (at step 610) and sends (at step 612) the software application (e.g., in the form of a software package) and an install command to software platform 124. This zip file is different than the zip file that is validated in step 604 above.

At step 614, software platform 124 sends a notification, to RXOP 114, that indicates whether the software application and install command was received. At steps 616-618, RXOP 114 confirms with software platform 124 whether the software application is installed on printing device 120. At step 620, if the entire process completed successfully, then RXOP 114 sends a successful notification to client 112; otherwise, RXOP 114 sends an unsuccessful notification to client 112.

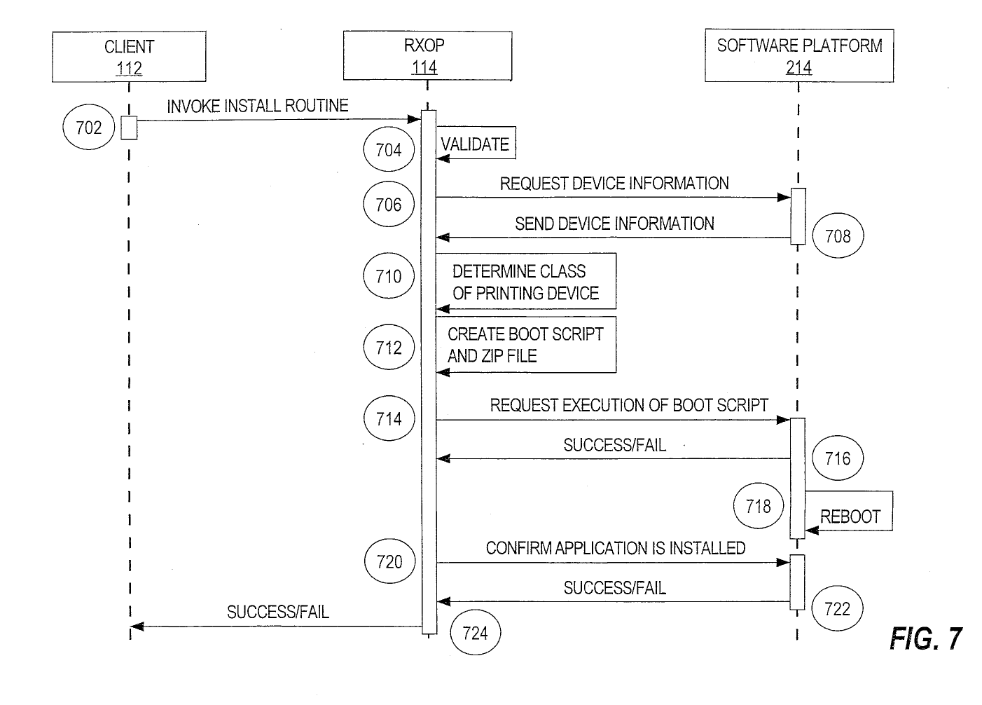

FIG. 7 is a sequence diagram that depicts a process for installing a software application that requires a printing device to perform a reboot operation, according to an embodiment of the invention. Steps 702-708 are similar to steps 602-608 described above. At step 710, RXOP 114 determines whether printing device 120 is a member of a particular class (or family) of devices. This step may be performed as part of confirming that software platform 124 can support the software application. If printing device 120 is a member of a particular class of devices, then, at step 712, RXOP 114 creates a boot script file and, optionally, packages the boot script file in a file (e.g., a zip file) that contains the software application. At step 714, RXOP 114 sends the boot script file and the software application to software platform 124. At step 716, software platform 124 sends, to RXOP 114, a notification that indicates that the boot script file and software application were received.

At step 718, software platform 124 causes printing device 120 to reboot, which reboot causes the boot script file to be executed. At step 720, after RXOP 114 waits for printing device 120 to reboot, RXOP 114 confirms with software platform 124 whether the software application is installed on printing device 120. In an embodiment, at step 720, RXOP 114 requests, from software platform 124, the same software information requested in step 706. At step 722, software platform 124 sends the requested software information.

At step 724, if the entire process completed successfully, then RXOP 114 sends a successful notification to client 112; otherwise, RXOP 114 sends an unsuccessful notification to client 112.

### “Smart” Installation

FIG. 8 is a sequence diagram that depicts a process for “smart installation” of a software application, according to an embodiment of the invention. In summary, “smart installation” comprises determining the current version of software platform 124 and, if necessary, installing an updated version of software platform 124 to guarantee compatibility between the software application and software platform 124.

At step 802, client 112 invokes an install routine to install a particular version of a software application. At step 804, in response to the invocation of the install routine, RXOP 114 requests software information from software platform 124. Software information may include the versions of the current software applications executing on printing device 120 and the version of software platform 124.

At step 806, software platform 124 sends the requested software information to RXOP 114. At step 808 RXOP 114 determines, based on the software information, whether the software application on printing device 120 should be updated. This may be determined by comparing the version of the software application on printing device 120 with the version of the software application identified by client 112.

At step 810, RXOP 114 determines, based on the software information, whether software platform 124 should be updated. Software platform 124 may be updated simply because a newer version is available on client device 110. Alternatively, software platform 124 may be updated in order to support the new version of the software application.

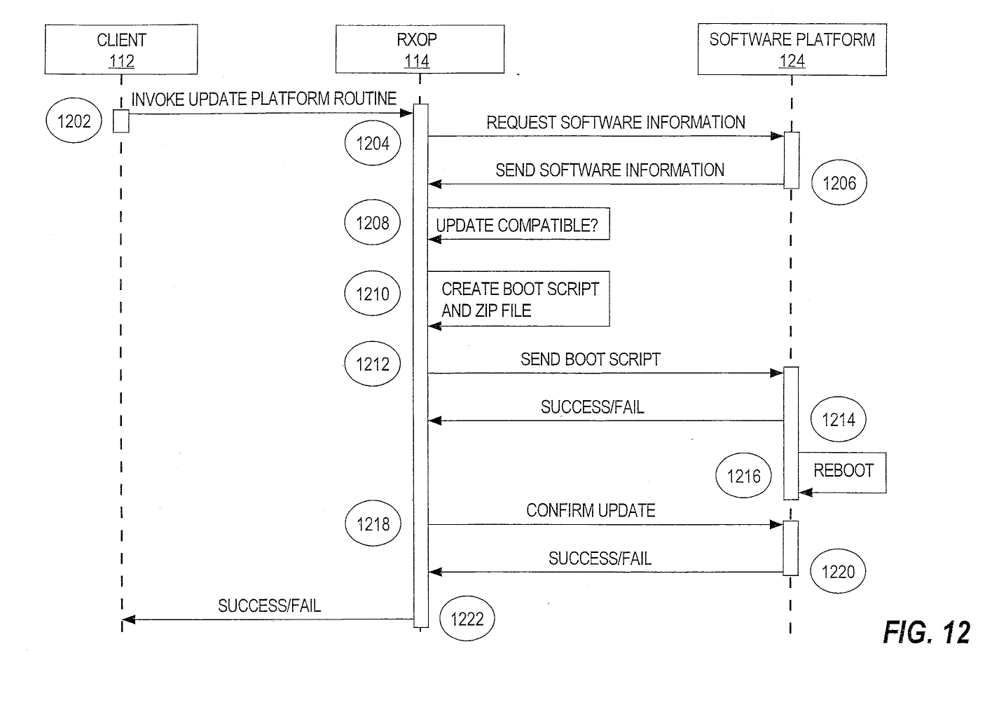

At step 812, if software platform 124 should be updated, then RXOP 114 sends an update software platform command and an updated version of software platform 124 to software platform 124. FIG. 12, which is described below, depicts a process for updating software platform 124.

At step 814, if printing device 120 can be updated with the new software application, then RXOP 114 sends the new software application and an install command to software platform 124. At step 816, software platform 124 sends a notification, to RXOP 114, of whether the software application was successfully installed. At step 818, RXOP 114 informs client 112 whether the install routine completed successfully.

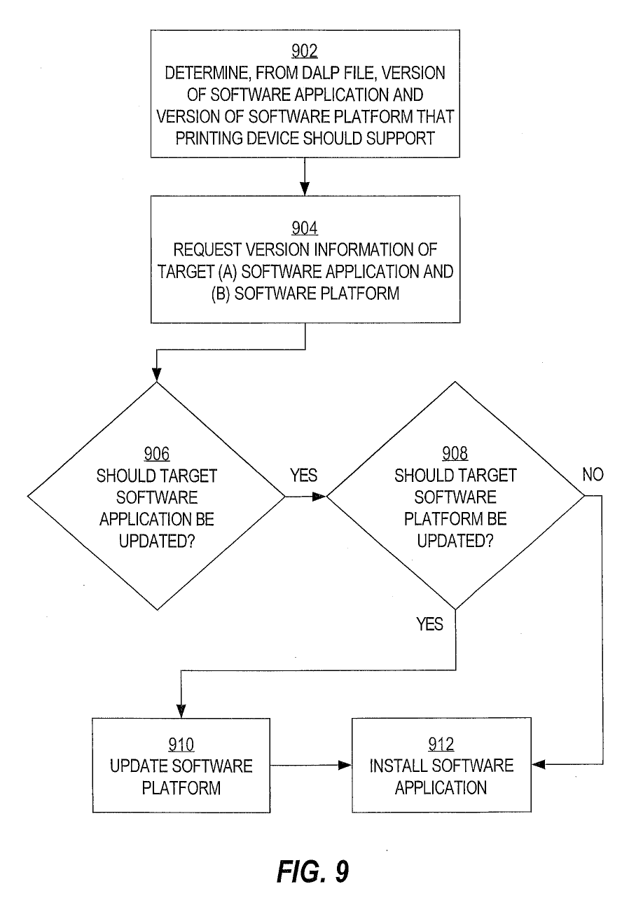

FIG. 9 is a flow diagram that depicts another view of “smart installation”, according to an embodiment of the invention. At step 902, RXOP 114 determines, from the dalp file of a software package from client 112, the version of the software application to be installed and the version of a software platform that printing device 120 should support.

At step 904, RXOP 114 sends a request, to software platform 124, for version information (a) of the corresponding software application that is executing on printing device 120 (referred to herein as the “target software application”) and (b) of software platform 124.

At step 906, based on the version information of the target software application and of the to-be-installed software application, RXOP module determines whether the target software application should be updated. For example, if the target software application is the same as the version of the software application in the software package, then no software update is necessary. In that case, the process ends.

Otherwise, if the target software application should be updated, then, at step 908, RXOP 114 determines, using version information, whether software platform 124 should be updated. If not, then, at step 912, RXOP 114 sends an install command and the software package to printing device 120.

If the determination at step 908 is positive, then, at step 910, RXOP 114 sends a software platform update and a different version of software platform 124 to printing device 120. RXOP 114 also performs step 912.

### Uninstalling Software Applications

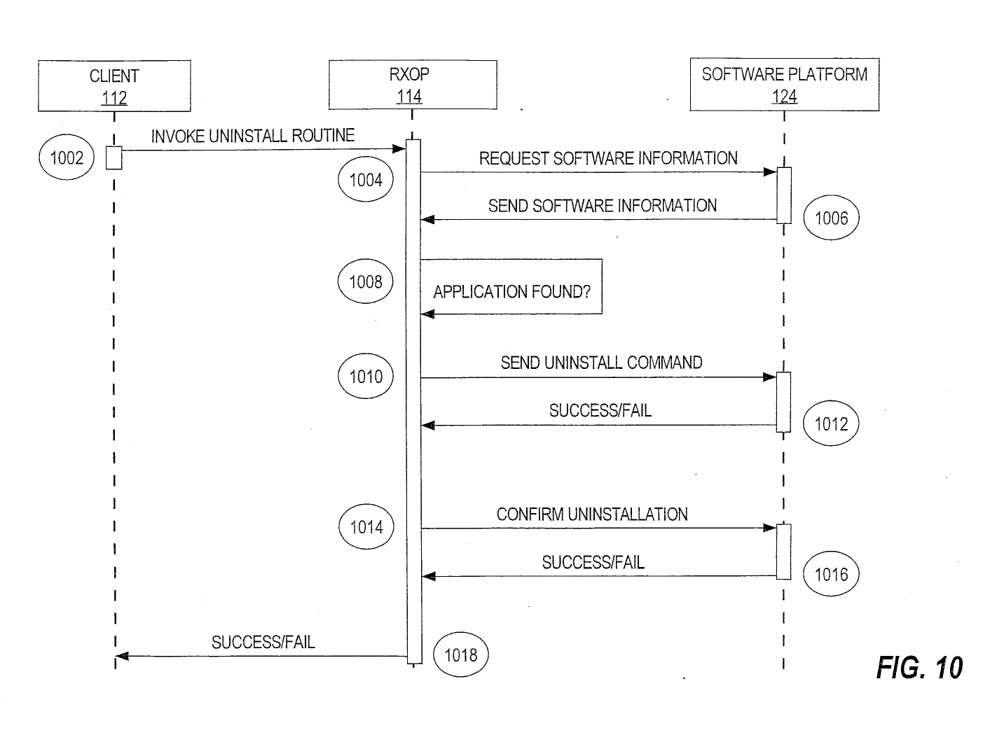

FIG. 10 is a sequence diagram that depicts a process for uninstalling a software application that does not require a printing device to perform a reboot operation, according to an embodiment of the invention. At step 1002, client 112 invokes an uninstall routine and passes an identification of a particular software application. At step 1004, in response to the invocation of the uninstall routine, RXOP 114 sends a request, to software platform 214, for software information that indicates the software applications that are already installed on the device. At step 1006, printing device 120 sends the requested software information to RXOP 114. At step 1008, RXOP 114 determines, based on the device information, whether the particular software application is identified in the device information. If the particular software application is not identified in the software information, then the process proceeds to step 1018, where RXOP 114 informs client 112 that the particular software application was not found on printing device 120. If the particular software application is identified in the software information, then at least steps 1010-1012 are performed.

At step 1010, RXOP 114 sends an uninstall command that identifies the particular software application to software platform 124. At step 1012, software platform 124 sends, to RXOP 114, a success or fail message that indicates that the uninstall command was received.

At step 1014, RXOP 114 confirms with software platform 124 whether the particular software application was uninstalled. Steps 1014-1016 may comprise RXOP 114 requesting, from software platform 124, the same software information requested in step 1004. At step 1018, RXOP 114 informs client 112 whether the particular software application was uninstalled successfully.

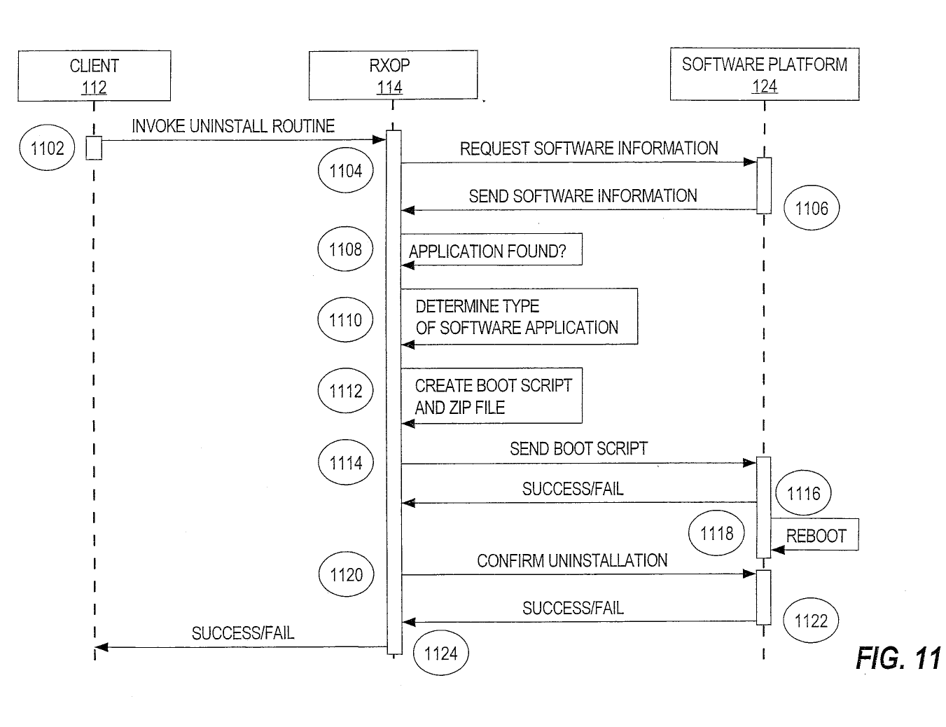

FIG. 11 is a sequence diagram that depicts a process for uninstalling a software application that requires a printing device to perform a reboot operation, according to an embodiment of the invention. Steps 1102-1108 are similar to steps 1002-1008. If the particular software application is not identified in the software information, then the process proceeds to step 1124, where RXOP 114 informs client 112 that the particular software application is not installed on printing device 120.

If the particular software application is identified in the software information, then, at step 1110, RXOP 114 determines whether the particular software application is of a particular type. Certain software applications, when uninstalled, do not require printing device 120 to reboot in order to complete the uninstall process. The type of software application thus indicates whether a reboot operation needs to be performed. If the particular software application is not of the particular type, then the process proceeds to step 1010 of FIG. 10.

If the particular software application is of the particular type, then, at step 1112, RXOP 114 creates a boot script file and, optionally, packages the boot script file in a zip file. At step 1114, RXOP 114 sends the boot script file to software platform 124. At step 1116, software platform 124 sends, to RXOP 114, a message that indicates whether the boot script file was received.

At step 1118, software platform 124 causes printing device 120 to reboot, which reboot causes the boot script file to be executed. At step 1120, after waiting for printing device 120 to reboot, RXOP 114 confirms with software platform 124 whether the particular software application was uninstalled. Steps 1120-1122 may comprise RXOP 114 requesting, from software platform 124, the same software information requested in step 1104 and software platform 124 sending the requested software information.

At step 1124, RXOP 114 informs client 112 whether the particular software application was uninstalled successfully.

### Updating a Software Platform

FIG. 12 is a sequence diagram that depicts a process for updating a software platform of a printing device, according to an embodiment of the invention. At step 1202, client 112 invokes an update software platform routine. In response, at step 1204, RXOP 114 sends a request to software platform 124 to retrieve software information that indicates the current version of software platform 124. At step 1206, software platform 124 sends the requested software information to RXOP 114.

At step 1208, RXOP 114 determines, based on the software information, whether the requested software platform update is compatible with software platform 124. For example, the software platform update may not be compatible with software platform 124 if the software platform update is not a later version relative to the current version of target software platform 124. As another example, the software platform update may not be compatible with target software platform 124 if the updated software platform is for a class of devices that does not include printing device 120.

If the software platform update is not compatible with target software platform 124, then the process proceeds to step 1222, where RXOP 114 informs client 112 that the software platform update is not compatible with software platform 124.

If the software platform update is compatible with software platform 124, then, at step 1210, RXOP 114 creates a boot script and, optionally, packages the boot script in a zip file. At step 1212, RXOP 114 sends the boot script file to software platform 124. At step 1214, software platform 124 sends, to RXOP 114, a message that indicates whether the boot script file was received.

At step 1216, software platform 124 causes printing device 120 to reboot, which reboot causes the boot script file to be executed. At step 1218, after waiting for printing device 120 to reboot, RXOP 114 confirms with software platform 124 whether the software platform 124 was appropriately updated. Steps 1218-1220 may comprise RXOP 114 requesting, from software platform 124, the same software information requested in step 1204 and software platform 124 sending the requested software information.

At step 1222, RXOP 114 informs client 112 whether the particular software application was uninstalled successfully.

### Hardware Overview

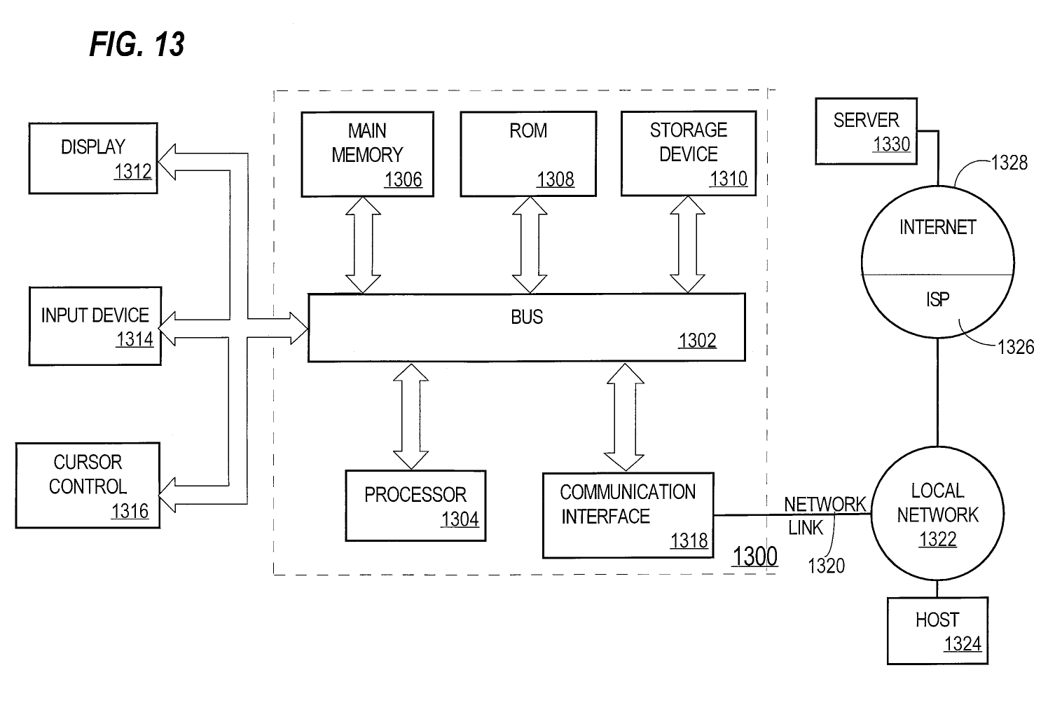

FIG. 13 is a block diagram that illustrates a computer system 1300 upon which an embodiment of the invention may be implemented. Computer system 1300 includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

The invention is related to the use of computer system 1300 for implementing the techniques described herein. According to one embodiment of the invention, those techniques are performed by computer system 1300 in response to processor 1304 executing one or more sequences of one or more instructions contained in main memory 1306. Such instructions may be read into main memory 1306 from another machine-readable medium, such as storage device 1310. Execution of the sequences of instructions contained in main memory 1306 causes processor 1304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1300, various machine-readable media are involved, for example, in providing instructions to processor 1304 for execution. Such a medium may take many forms, including but not limited to storage media and transmission media. Storage media includes both non-volatile media and volatile media. Non-volatile media includes, for example, optical or magnetic disks, such as storage device 1310. Volatile media includes dynamic memory, such as main memory 1306. Transmission media includes coaxial cables, copper wire and fiber optics, including the wires that comprise bus 1302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1304 for execution. For example, the instructions may initially be carried on a magnetic disk of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are exemplary forms of carrier waves transporting the information.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution. In this manner, computer system 1300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A client device for updating a current version of a virtual machine on a plurality of printing devices, wherein one or more applications execute on the virtual machine, the client device comprising:
an update library of routines; and
an update application that is configured to invoke multiple routines in the update library;
wherein the client device is configured to send, in response to the update application invoking a first routine from the update library, over a network to each of the plurality of printing devices, a plurality of instructions and a different version of the virtual machine,
wherein each of the plurality of printing devices is capable of generating a printed version of an electronic document reflected in electronic print data,
wherein each of the plurality of printing devices, in response to receiving the plurality of instructions and the different version:
uninstalls the current version of the virtual machine,
installs the different version of the virtual machine, and
performs a reboot operation.

2. The client device of claim 1, wherein the client device is configured to validate, in response to the update application invoking the first routine and before sending the plurality of instructions, the different version of the virtual machine to determine whether the different version of the virtual machine is packaged according to a particular specification.

3. The client device of claim 1, wherein:
the client device is further configured to send, in response to the update application invoking a second routine from the update library, over the network to each printing device of a second plurality of printing devices, a second plurality of instructions and a software application; and
said each printing device, of the second plurality, installs the software application in response to receiving the second plurality of instructions.

4. The client device of claim 3, wherein the client device is further configured to, in response the update application invoking the second routine:
for each printing device of the second plurality of printing devices, determine, based on the type of the software application, whether said each printing device requires a reboot operation to be performed after the software application is installed;
for each printing device of the second plurality that requires the reboot operation to be performed, generate a boot script; and
for each printing device of the second plurality of printing devices, generate a zip file that includes the software application, wherein the zip file for a printing device of the second plurality that requires the reboot operation to be performed also includes the boot script;
wherein sending the second plurality of instructions and the software application includes sending the zip file to said each printing device of the second plurality.

5. The client device of claim 1, wherein the client device is further configured to:
retrieve, in response to receiving an invocation of a second routine, device information from each printing device of a second plurality of printing devices, wherein:
the second routine is to install a different version of a currently-installed software application on each printing device of the second plurality, and
the device information indicates one or more of the following of said each printing device of the second plurality: device type, device model, the currently-installed version of the software application, or the currently-installed version of the virtual machine; and
for each printing device of the second plurality:
determine, based on the device information, whether the different version is newer relative to the currently-installed version of the software application on said each printing device;
determine, in response to determining that the different version is newer, whether an update of the currently-installed virtual machine is available;
send, in response to determining that an update of the currently-installed virtual machine is available, to said each printing device, a second plurality of instructions to update the currently-installed version of the virtual machine; and
send, to said each printing device, in response to determining that the different version is newer, a third plurality of instructions to install the different version of the software application.

6. The client device of claim 1, wherein:
a first instruction of the plurality of instructions is an instruction to lock a central panel of said each printing device before said each printing device uninstalls the current version;
said each printing device locks the central panel in response to processing the first instruction;
a second instruction of the plurality of instructions is an instruction to unlock the central panel after said each printing device performs the reboot operation; and
said each printing device unlocks the central panel in response to processing the second instruction.

7. The client device of claim 1, wherein:
a first instruction of the plurality of instructions is a request for version information of the current version of the virtual machine of said each printing device;
in response to processing the first instruction, said each printing device provides the version information to the client device;
in response to receiving the version information from said each printing device, the client device is further configured to determine whether the different version is compatible with the current version of the virtual machine;
in response to determining that the different version is compatible with the current version of the virtual machine of said each printing device, the client device is further configured to create a boot script and send the boot script to said each printing device.

8. A machine-readable storage medium storing instructions for updating a current version of a virtual machine on a plurality of printing devices, wherein one or more applications execute on the virtual machine, wherein the instructions, when executed by one or more processors, cause the one or more processors to perform the steps of:
an update application invoking multiple routines in an update library of routines;
in response to the update application invoking a first routine from the update library, sending, over a network to each of the plurality of printing devices, a plurality of instructions and a different version of the virtual machine,
wherein each of the plurality of printing devices is capable of generating a printed version of an electronic document reflected in electronic print data,
wherein each of the plurality of printing devices, in response to receiving the plurality of instructions and the different version:
uninstalls the current version of the virtual machine,
installs the different version of the virtual machine, and
performs a reboot operation.

9. The machine-readable storage medium of claim 8, wherein the instructions include instructions which, when executed by the one or more processors, further cause the one or more processors to perform the step of validating, in response to the update application invoking the first routine and before sending the plurality of instructions, the different version of the virtual machine to determine whether the different version of the virtual machine is packaged according to a particular specification.

10. The machine-readable storage medium of claim 8, wherein:
the instructions include instructions which, when executed by the one or more processors, further cause the one or more processors to perform the step of sending, in response to the update application invoking a second routine from the update library, over the network to each printing device of a second plurality of printing devices, a second plurality of instructions and a software application; and
said each printing device, of the second plurality, installs the software application in response to receiving the second plurality of instructions.

11. The machine-readable storage medium of claim 10, wherein the instructions include instructions which, when executed by the one or more processors, further cause the one or more processors to perform the steps of, in response the update application invoking the second routine:
for each printing device of the second plurality of printing devices, determining, based on the type of the software application, whether said each printing device requires a reboot operation to be performed after the software application is installed;
for each printing device of the second plurality that requires the reboot operation to be performed, generating a boot script; and
for each printing device of the second plurality, generating a zip file that includes the software application, wherein the zip file for a printing device of the second plurality that requires the reboot operation to be performed also includes the boot script;
wherein sending the second plurality of instructions and the software application includes sending the zip file to said each printing device of the second plurality.

12. The machine-readable storage medium of claim 8, wherein the instructions include instructions which, when executed by the one or more processors, further cause the one or more processors to perform the steps of:
in response to the update application invoking a second routine, retrieving device information from each printing device of a second plurality of printing devices, wherein:
the second routine is to install a different version of a currently-installed software application on each printing device of the second plurality, and
the device information indicates one or more of the following of said each printing device of the second plurality: device type, device model, the currently-installed version of the software application, or the currently-installed version of the virtual machine; and
for each printing device of the second plurality:
determining, based on the device information, whether the different version is newer relative to the currently-installed version of the software application on said each printing device;
in response to determining that the different version is newer, determining whether an update of the currently-installed virtual machine is available;
in response to determining that an update of the currently-installed virtual machine is available, sending, to said each printing device, a second plurality of instructions to update the currently-installed version of the virtual machine; and
in response to determining that the different version is newer, sending to said each printing device, a third plurality of instructions to install the different version of the software application.

13. The machine-readable storage medium of claim 8, wherein:
a first instruction of the plurality of instructions is an instruction to lock a central panel of said each printing device before said each printing device uninstalls the current version;
said each printing device locks the central panel in response to processing the first instruction;
a second instruction of the plurality of instructions is an instruction to unlock the central panel after said each printing device performs the reboot operation; and
said each printing device unlocks the central panel in response to processing the second instruction.

14. The machine-readable storage medium of claim 8, wherein:
a first instruction of the plurality of instructions is a request for version information of the current version of the virtual machine of said each printing device;
in response to processing the first instruction, said each printing device provides the version information to the client device;
the instructions include instructions which, when executed by the one or more processors, further cause the one or more processors to perform the steps of:
in response to receiving the version information from said each printing device, determining whether the different version is compatible with the current version of the virtual machine;
in response to determining that the different version is compatible with the current version of the virtual machine of said each printing device, creating a boot script and sending the boot script to said each printing device.

15. A method for updating a current version of a virtual machine on a plurality of printing devices, wherein one or more applications execute on the virtual machine, the method comprising:
an update application invoking multiple routines in an update library of routines;
in response to the update application invoking a first routine from the update library, sending, over a network to each of the plurality of printing devices, a plurality of instructions and a different version of the virtual machine,
wherein each of the plurality of printing devices is capable of generating a printed version of an electronic document reflected in electronic print data,
wherein each of the plurality of printing devices, in response to receiving the plurality of instructions and the different version:
uninstalls the current version of the virtual machine,
installs the different version of the virtual machine, and
performs a reboot operation.

16. The method of claim 15, further comprising validating, in response to the update application invoking the first routine and before sending the plurality of instructions, the different version of the virtual machine to determine whether the different version of the virtual machine is packaged according to a particular specification.

17. The method of claim 15, wherein:
the method further comprising sending, in response to the update application invoking a second routine from the update library, over the network to each printing device of a second plurality of printing devices, a second plurality of instructions and a software application; and
said each printing device, of the second plurality, installs the software application in response to receiving the second plurality of instructions.

18. The method of claim 17, further comprising, in response the update application invoking the second routine:
for each printing device of the second plurality of printing devices, determining, based on the type of the software application, whether said each printing device requires a reboot operation to be performed after the software application is installed;
for each printing device of the second plurality that requires the reboot operation to be performed, generating a boot script; and
for each printing device of the second plurality, generating a zip file that includes the software application, wherein the zip file for a printing device of the second plurality that requires the reboot operation to be performed also includes the boot script;
wherein sending the second plurality of instructions and the software application includes sending the zip file to said each printing device of the second plurality.

19. The method of claim 15, further comprising:
in response to the update application invoking a second routine, retrieving device information from each printing device of a second plurality of printing devices, wherein:
the second routine is to install a different version of a currently-installed software application on each printing device of the second plurality, and
the device information indicates one or more of the following of said each printing device of the second plurality: device type, device model, the currently-installed version of the software application, or the currently-installed version of the virtual machine; and
for each printing device of the second plurality:
determining, based on the device information, whether the different version is newer relative to the currently-installed version of the software application on said each printing device;
in response to determining that the different version is newer, determining whether an update of the currently-installed virtual machine is available;
in response to determining that an update of the currently-installed virtual machine is available, sending, to said each printing device, a second plurality of instructions to update the currently-installed version of the virtual machine; and
in response to determining that the different version is newer, sending to said each printing device, a third plurality of instructions to install the different version of the software application.

20. The method of claim 15, wherein:
a first instruction of the plurality of instructions is an instruction to lock a central panel of said each printing device before said each printing device uninstalls the current version;
said each printing device locks the central panel in response to processing the first instruction;
a second instruction of the plurality of instructions is an instruction to unlock the central panel after said each printing device performs the reboot operation; and
said each printing device unlocks the central panel in response to processing the second instruction.

21. The method of claim 15, wherein:
a first instruction of the plurality of instructions is a request for version information of the current version of the virtual machine of said each printing device;
in response to processing the first instruction, said each printing device provides the version information to the client device;
the method further comprising:
in response to receiving the version information from said each printing device, determining whether the different version is compatible with the current version of the virtual machine;
in response to determining that the different version is compatible with the current version of the virtual machine of said each printing device, creating a boot script and sending the boot script to said each printing device.
